(19) United States
(12) Patent Application Publication
(10) Pub. No.: US 2009/0086706 A1
(43) Pub. Date: Apr. 2, 2009

(54) CROSS-LAYER MULTI-PACKET RECEPTION BASED MEDIUM ACCESS CONTROL AND RESOURCE ALLOCATION

(75) Inventors: Weilan Huang, Hong Kong (CN); Khaled Ben Letaief, Hong Kong (CN)

Correspondence Address: AMIN, TUROCY & CALVIN, LLP, 127 Public Square, 57th Floor, Key Tower, CLEVELAND, OH, 44114, US

(73) Assignee: THE HONG KONG UNIVERSITY OF SCIENCE AND TECHNOLOGY, Hong Kong (CN)

(21) Appl. No.: 11/865,477

(22) Filed: Oct. 1, 2007

(51) Int. Cl. H04J 3/24; H04L 12/413

(52) U.S. Cl. 370/349; 370/448

(57) ABSTRACT

A cross-layer multi-packet reception media access control and resource allocation technique is provided for wireless networks having receivers with multiple antennas. User devices on the wireless network access the network for data transmission by making a request to send (RTS) request after a random backoff time. In response to a request to send, an access point (or other receiver) determines transmission parameters that optimize the use of the physical layer based at least in part on channel state information. Those transmission parameters are transmitted along with a clear to send (CTS) message from the receiver to an indicated transmitter. Once the CTS message is received, data is transmitted in accordance with transmission parameters.

### TECHNICAL FIELD

The subject disclosure relates to wireless network communications and, more specifically, multi-input multi-output and single-input multi-output based wireless networks.

### BACKGROUND

Wireless networks (WLANs), such as IEEE 802.11-based wireless local area networks (WLANs), are increasingly popular and widely deployed. However, conventional WLANs usually operate far away from theoretical limits, especially under high network load. One crucial reason for this is that these systems are designed based on a layered approach that is typically inefficient. In particular, medium access control protocols are designed without taking into consideration the characteristics of the physical layer. At the same time, the physical-layer resources are usually under-utilized because media access control issues are not taken into consideration.

For example, media access control protocols in conventional 802.11-based systems (e.g., 802.11a, 802.11b, 802.11g) employ a simplistic collision model which only supports one simultaneous transmission. In particular, 802.11-based systems are based on a carrier sense multiple access protocol with collision avoidance (CSMA/CA). Such an idealized model is both optimistic and pessimistic. The model is optimistic because there is an assumption of error-free reception, which ignores channel effects such as fading and noise; however, the model is pessimistic because it does not exploit the capability of the physical layer to successfully decode multiple packets in the presence of simultaneous transmissions. Recently, the IEEE 802.11n standardization effort, which aims at a higher throughput by deploying multiple antennas, has attracted much interest. However, its collision model is still essentially unchanged over previous 802.11-based collision models and does not allow multi-packet reception.

One possible solution for enabling multi-packet reception is to deploy adaptive antenna arrays at the transmitter and receiver ends, or multi-input multi-output (MIMO) technology so as to allow space division multiple access (SDMA). A special case of MIMO is single-input multi-output (SIMO) with a single transmit antenna and multiple receive antennas. On the other hand, orthogonal frequency division multiplexing (OFDM) is adopted in most of the current 802.11 systems, for its capability to efficiently utilize the limited RF bandwidth and transmit power in wideband transmission over time-dispersive multi-path channels. Multiuser OFDM, or orthogonal frequency division multiple access (OFDMA), is another alternative to achieve multi-packet reception. The inherent multi-carrier nature of OFDMA systems also allows dynamic sub-carrier allocation combined with adaptive bit loading and power control so that the attainable data rates can be improved by exploiting the frequency as well as multiuser diversity. As such, the use of MIMO technology combined with OFDM is an attractive solution for broadband wireless systems.

However, the existing formulations of resource allocation do not fit 802.11-like systems well and most formulations do not take media access control issues into consideration. Moreover, existing allocation methods are hardly thorough solutions for multiuser MIMO/OFDM systems.

For example, there are two main techniques for exploiting transmit antenna arrays in MIMO systems: space-time coding and transmit beamforming. These two strategies are based on two different and extreme assumptions regarding channel feedback available at the transmitter. Space-time coding requires no feedback, whereas conventional beamforming requires accurate feedback. Space-time coding is too pessimistic in its assumptions and the assumption with conventional beamforming is rarely valid.

The above-described deficiencies of MIMO-based wireless network are merely intended to provide an overview of some of the problems of today's MIMO based wireless networks, and are not intended to be exhaustive. Other problems with the state of the art may become further apparent upon review of the description of various non-limiting embodiments that follows.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments of the invention in a simplified form as a prelude to the more detailed description of the various embodiments of the invention that follows.

A cross-layer multi packet reception media access control and resource allocation technique is provided for wireless networks having receivers with multiple antennas. User devices on the wireless network access the network for data transmission by making a request to send (RTS) request after a random backoff time. In response to a request to send, an access point (or other receiver) determines transmission parameters that optimize the use of the physical layer. Transmitter parameters can include subcarrier, bit, and power allocation information. Those transmission parameters are transmitted along with a clear to send (CTS) message from the receiver to an indicated transmitter. Once the CTS message is received, data is transmitted in accordance with transmission parameters.

### BRIEF DESCRIPTION OF THE DRAWINGS

The system and methods for cross-layer multiple packet reception media access control and resource allocation are further described with reference to the accompanying drawings in which:

FIG. 1 illustrates a MIMO wireless network operating environment;

FIG. 2 illustrates protocol operation according to one embodiment;

FIG. 3 is an exemplary transmitter during data transmission;

FIG. 4 is an exemplary receiver during data transmission;

FIG. 5 illustrates the structure of space-time-coded beamformer according to one embodiment;

FIG. 6 is a chart illustrating the relationship between ρ and the bit error rate for various resource allocation techniques;

FIG. 7 is a chart illustrating the relationship between signal-to-noise ratio per subcarrier and average number of OFDM symbols per packet for various resource allocation techniques;

FIG. 8 is a chart illustrating the relationship between signal-to-noise ratio per subcarrier and throughput for various resource allocation techniques;

FIG. 9 is a chart illustrating the relationship between the number of users and throughput for various resource allocation techniques;

FIG. 10 is a chart illustrating the relationship between packet arrival rate and average packet delay for various resource allocation techniques;

FIG. 11 is a chart illustrating the relationship between signal-to-noise ratio per subcarrier to average packet delay for various resource allocation techniques;

FIG. 12 is a chart illustrating the relationship between packet arrival rate and throughput for various resource allocation techniques;

FIG. 13 illustrates an exemplary system according to one embodiment;

FIG. 14 is a flowchart of an exemplary method performed by a user device transmitter according to one embodiment;

FIG. 15 is a flowchart of an exemplary method performed by a receiver according to one embodiment; and

FIG. 16 is a block diagram representing an exemplary non-limiting computing system or operating environment in which the present invention may be implemented.

### DETAILED DESCRIPTION

### Overview

As discussed in the background, existing media access and resource allocation techniques for multiuser MIMO (and other multiuser multiple antenna systems, such as SIMO) systems are inefficient. One of the reasons for this inefficiency is due to challenges behind the resource allocation problems of such systems. For example, the quantifying and handling of co-channel interference is not a trivial task, as this depends on the transmission scheme and detection technique at the receiver, the accuracy of channel information, users' spatial separability, as well as, the transmitted power of all admitted users. As a second example, the selection of the user set for each sub-carrier usually needs a combinatorial search of optimal solutions, which makes the allocation prohibitively complicated.

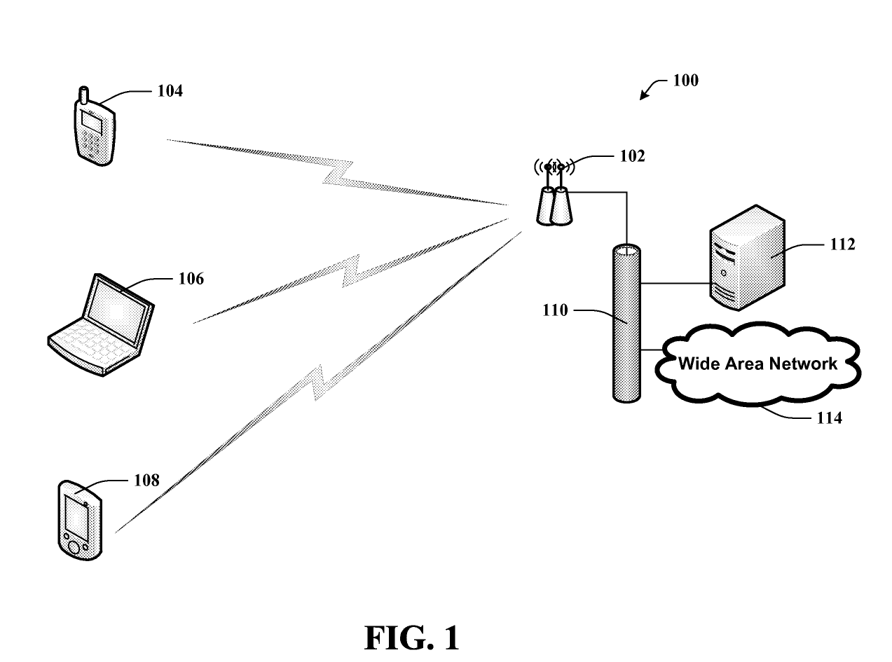

Referring to FIG. 1, an exemplary wireless network 100 is illustrated. Although a simple wireless local area network is illustrated for the sake of clarity, one will appreciate that the technique can be used for wireless networks of different sizes and local area networks that are more complex. Various user devices (104, 106, 108) (hereinafter referred to simply as users) are illustrated as connecting to the network. Any user device, such as a gaming console, handheld computer, laptop computer 106, smartphone 104, personal digital assistant 108, desktop computer, or embedded computers in household appliances (e.g., microwave or refrigerator) can be attached to the wireless network in some embodiments. The device can have an internal connection to the wireless network or can be connected to an external device to connect it to the wireless network (e.g., an Ethernet to wireless adapter). In this illustration, each of the users is in wireless communication with access point 102. One will appreciate that a wireless network can contain multiple access points in other embodiments. In addition, one will appreciate that in other embodiments the wireless network can operate in peer-to-peer mode instead of in infrastructure mode. Both the access point and the user devices each have multiple antennas.

The access point 102 is usually connected to a wired network 110, such as an Ethernet network. However, one will appreciate that access point can connect to a second wireless network. Various servers 112 can be connected to the wired network and provide various services (e.g., file serving, email, web portal, print server, etc.). Although not shown, other devices, such as network printers or scanners can also be connected via the wired network. Usually, the wired network will also be connected to a wide area network 114, such as the Internet.

### A MIMO/OFDM Based WLAN Embodiment

The following notations are used. (•)*, (•)^{T} and (•)^{H} denote conjugate, transpose and Hermitian transpose, respectively. |•| stands for the complex norm, E[•] for the expectation operation, and CN(μ,Σ) for a complex Gaussian distribution with mean μ and covariance matrix Σ.

For the sake of clarity, an exemplary embodiment is considered in the context of a simplified MIMO/OFDM based WLAN. However, one will appreciate that the cross-layer media access control and resource allocation can be used in other types of multi-packet reception wireless networks. In particular, the uplink transmission of a MIMO/OFDM based WLAN system is considered where a number of mobile users or nodes communicate with one access point (AP). In this example scenario, there are total of Kₜ users in the system, each equipped with Mₜ transmit antennas and the AP is equipped with Mᵣ receive antennas. A feature of the media access control protocol is that it incorporates adaptive resource allocation into the protocol through the use of RTS/CTS exchange. As a result, the multi-packet reception capability in this illustrated embodiment will not only result from the use of SDMA but also OFDMA.

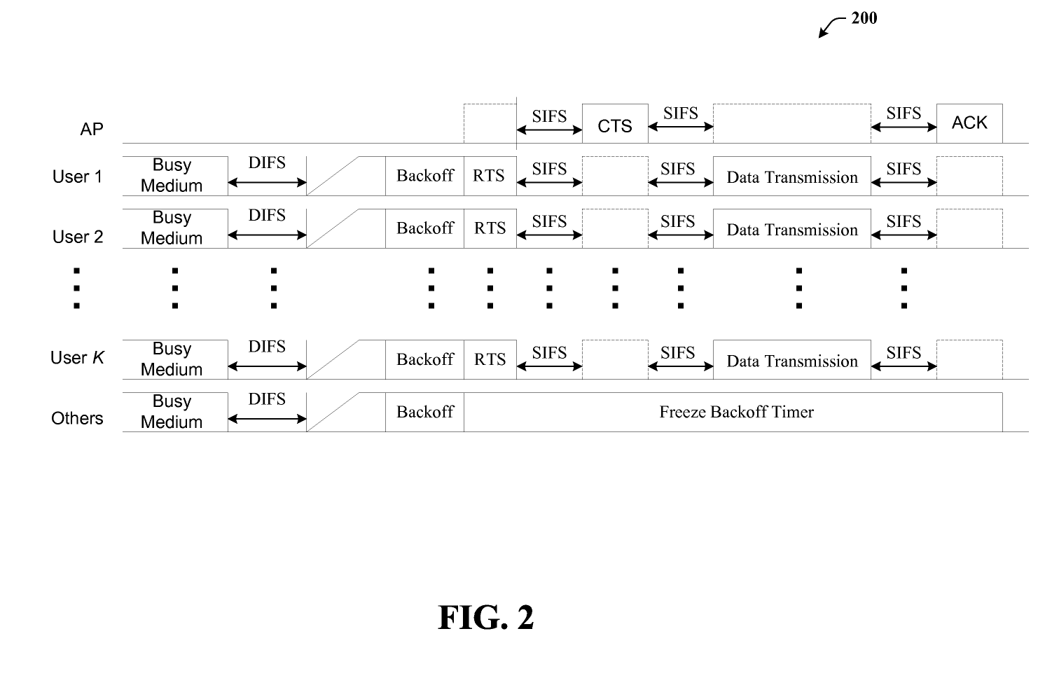

The protocol operation according to one embodiment is illustrated in FIG. 2. Before a user initiates a transmission, it senses the channel to determine whether there is any pending transmission. If the medium is found to be idle for an interval that exceeds the distributed inter-frame space (DIFS), each user chooses a random backoff counter value uniformly distributed in the range of [0,CW-1], where CW stands for contention window. CW is maintained in slot units and is initially set to be CWₘᵢₙ. After the random backoff time, an access request is then sent via a Request To Send (RTS) packet, which carries the information of the source and destination address.

Since the AP has no prior knowledge of the transmitting users, a blind detection technique is applied to estimate the channel state information and decode multiple RTS packets simultaneously. Any other user sensing the RTS will freeze its backoff timer at once. In this illustrated embodiment, the RTS packets also contain the information of the data packets' length. Upon receiving the access request, the AP utilizes the information of the channel and packets' length to perform cross-layer resource allocation of the subcarriers, bits and power. The parameters of the space-time-coded beamformers are also computed at the same time. After a short inter-frame space (SIFS), the access grant signals are then broadcast via a Clear To Send (CTS) packet to notify the specified user of the allocation results and channel information. The CTS packet provides space-time-coded beamformer parameters instead of the actual channel gains. Once a CTS packet is received by the user, the selected user waits for a SIFS interval and begins to transmit the data packets. Orthogonal training sequences, which are to be transmitted in the preamble of the data packets, can be selected according to the order of the received user addresses in the CTS packet. When the data transmission is finished, the AP checks the received packets. An acknowledgement (ACK) is then returned to the user for successful data transmissions after a SIFS interval. The channel state information used for allocation is estimated upon the reception of the RTS packets, which can become partially outdated for data transmission because of the Doppler effect.

The AP in this illustrated embodiment is assumed to be able to successfully receive the RTS packets if the number of users which are simultaneously sending RTS packets does not exceed the number of receive antennas. As a result, the number of admitted users K, which can be supported simultaneously, is no larger than Mᵣ. In particular, admitted users are those who simultaneously choose the minimum backoff time. If a collision occurs (e.g., when the number of users simultaneously sending RTS packets exceeds Mᵣ), the contention window is doubled for each retransmission until it reaches a maximum value CWₘₐₓ. Furthermore, if a packet error is detected and an ACK is not received within acknowledgement timeout period (ACKₜᵢₘₑₒᵤₜ), retransmission occurs. Upon successful transmission of a packet, CW is reset to CWₘᵢₙ.

During the RTS transmission, conventional space-time coding is employed at a transmitter and accordingly blind detection is applied at an AP for receiving multiple RTS packets. Upon successfully decoding RTS packets, the AP can identify the senders and inform them of the orthogonal training sequences which will be used during the data transmission phase. As a result, channel state information is estimated in the preamble of data frames, and with which multiuser detection techniques can be adopted to separate the multiple data packets at the receiver.

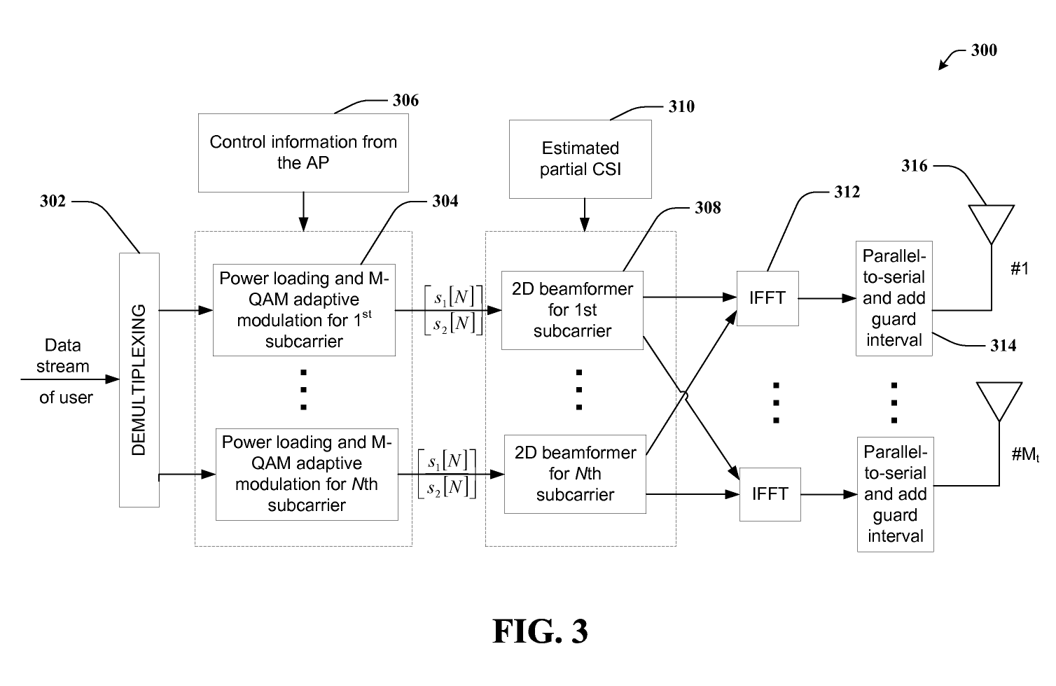

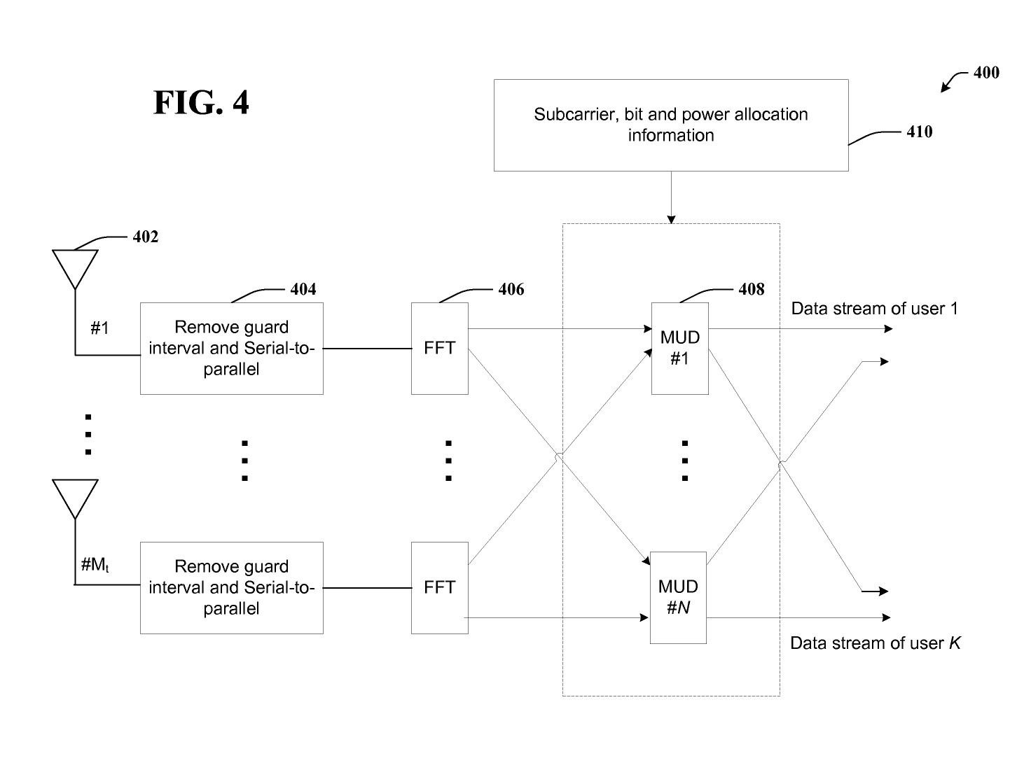

The configurations of an exemplary transmitter and receiver during the data packets' transmission are given in FIG. 3 and FIG. 4, respectively. The frequency band is divided into N subcarriers. The serial data stream of user k is transformed into a number of parallel branches by de-multiplexing 302. In order to form one space-time-coded OFDM block, two consecutive OFDM symbols are paired. Allocation results are sent as control information 306 from the AP to the receivers of mobile users via a CTS packet. Depending on the number of bits and power assigned to each subcarrier, the adaptive modulator can use a corresponding QAM modulation scheme 304. A space-time-coded beamformer 308 is then applied for each subcarrier. The resultant symbols can be transformed into time domain samples by inverse fast Fourier transform (IFFT) 312. A guard interval 314 is then added and these samples are transmitted through frequency selective fading channels to the AP via antenna 316.

At the receiver (e.g., an AP), the guard interval is removed 404 and the samples are transformed back into the frequency domain by the FFT block 406. With the knowledge of the channels and the space-time-coded beamformers for different users, multiuser detection 408 is applied to suppress the multi-access interference (MAI) and jointly estimate the transmitted signals for all users. The subcarrier, bit and power allocation information 410 is used to configure the multiuser detection.

Channel mean feedback is focused on where the spatial fading channels are modeled as Gaussian random variables with non-zero mean and white covariance conditioned on the channel feedback. This channel model can accommodate different types of partial channel state information, such as outdated channel state information caused by feedback delay and uncertain channel state information induced by channel estimation, prediction or feedback errors.

Channel state information, which in some embodiment is assumed to be perfectly estimated, is obtained upon the reception of the RTS packets. However, due to then time difference between the RTS and data packets, such channel state information will be partially outdated compared to the actual channel information. As a result, the assumption of partially outdated channel state information and associated transmitter design is made in at least some embodiments. Specifically, for sub-carrier n and user k, the Mᵣ×Mₜ MIMO channel is modeled as:

H[n, k]= H̅[n, k]+Ξ[n, k] (Equation 1)

where H̅[n, k] is the conditional mean of H[n, k] given the feedback information H^{∫}[n, k], and Ξ[n, k]˜CN(0_{M}_{ᵣ}_{×M}_{ₜ},Mₜσ_{ε}²[n, k]I_{M}_{ᵣ}) is the associated zero-mean perturbation matrix. The deterministic pair ( H̅[n, k],σ_{ε}²parameterizes the partially outdated channel state information and the variance σ_{ε}²[n, k] reflects the quality of the channel state information. When the finite impulse response (FIR) channels {h_{μv}[k]}_{μ=1, v=1}^{M}^{ₜ}^{,M}^{ᵣ} between different transmit and receive antenna pairs are independent and the L taps {h_{μ,v}[l, k]}ᵢ₌₁^{L} in h_{μv}[k] are uncorrelated:

$$ξ = \frac{E [ {H}^{f} [ n , k ] {H}^{ℋ} [ n , k ] ]}{E [ H [ n , k ] {H}^{ℋ} [ n , k ] ]} \\ and \\ {σ}_{ɛ}^{2} [ n , k ] = ( 1 - {\vert ξ \vert}^{2} ) {σ}_{h}^{2} , ∀ n , k \qquad ( Equation 2 )$$

where ξ denotes the correlation coefficient between the true channel and estimated channel in time domain while σₕ² is the total energy for all FIR channels of all the admitted users. When the Doppler effect is considered, ξ depends on the Doppler frequency ∫_{d} normalized by the time difference t_{Δ}. That is, ξ=J₀(2π∫_{d}t_{Δ}), where J₀(•) is the zero order Bessel function of the first kind.

Usually, in an 802.11-based wireless network in infrastructure mode, there is no information exchange between different users. As a result, each user designs a space-time-coded beamformer according to its own channel independently, without taking into consideration other mobile-to-AP links. A space-time-coded beamformer is configured for each user's transmitter. Since the transmitter configuration is similar for all users and sub-carriers, only a single user k and sub-carrier n are discussed below. However, one will appreciate that there are multiple users and multiple sub-carriers. For brevity, the square bracket [n, k] is dropped for the discussion below.

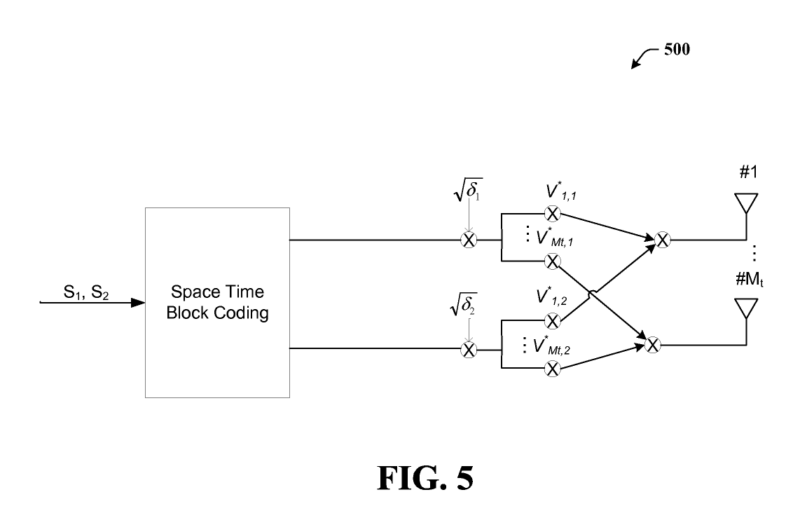

The structure of the space-time-coded beamformer is depicted in FIG. 5. The modulated symbols s₁ and s₂ are used to generate the Alamouti space-time matrix. However, one will appreciate that other space-time block code schemes can be used in other embodiments. The splitting of the transmit power with percentages δ₁, δ₂ results in δ₁P for the first basis-beam and δ₂P for the second basis-beam. The power-loaded symbols are then multiplied by two beamforming vectors v₁*=[v_{1,1}*, . . . , v_{M}_{ₜ}_{,1}*]^{T} and v₂*=[v_{1,2}*, . . . ,v_{M}_{ₜ}_{,2}*]^{T}, respectively. Variables (v₁, v₂, δ₁, δ₂) can be adjusted to optimize average bit error rate (BER) performance. Let d² denote the scaled square Euclidean distance for the constellation, which is a function of the power loading P and the number of loaded bits b. A threshold d₀² will then be used to achieve a target B̅E̅R̅ₜ̅.

Multiple users can transmit on the same sub-carriers and the superimposed signals can be separated at the receiver using multiple-antenna techniques. For each sub-carrier, a receiver (e.g., an AP) aims to estimate the transmitted modulated symbols from different users. The sub-carrier allocation information is then used to identify the corresponding users assigned to this sub-carrier. With the transmitter design, the architecture can be viewed as a space-time block coded (STBC) system where each symbol is transmitted through a beam. As a result, multiple user detection methods (MUDs), which were originally designed for multiuser STBC systems, can be applied to jointly detect the transmitted signals for different users. In one embodiment, maximum-likelihood (ML) multiuser detection is employed, which can be the optimal receive architecture that maximizes the posteriori probability. One will appreciate that other types of MUDs such as zero-forcing (ZF), minimum mean-square error (MMSE), parallel interference cancellation (PIC) and successive interference cancellation (SIC), can be also deployed at the receiver with reduced complexity.

As mentioned earlier, the challenges behind SDMA and the existence of co-channel interference (CCI) make resource allocation problems difficult to be solved. In order to deal with these problems, a grouping approach is employed, which divides all the users into groups, hopefully guaranteeing low interference between any pair of users from different groups.

A cross-layer approach is developed to maximize the system throughput. In order to achieve this, an optimal user combination can be selected from among all the admissible combinations for each sub-carrier and the bits and power are allocated based on partially outdated channel state information. The influence of users' separation is investigated on the allocation strategy. Such allocation strategy aims to indicate the condition under which users are allowed to share the same sub-carrier. A resource allocation problem can then formulated by considering both media access control and physical layer issues.

The allocation in MIMO/OFDM systems includes the selection of users on each subcarrier, as well as the bits, and power assignment for each user. A good allocation strategy should prevent the users of low separability from being assigned into the same sub-carriers because the resultant high interference will greatly reduce the system capacity. In order to achieve this and make the allocation problem tractable, user assignment is dynamically controlled according to the users' separability such that mutual interference can be substantially avoided. A users' separability can be determined by the correlation of the channel matrices between the users. However, partially outdated channel state information is available. As a result, the performance with different channel correlations is investigated as well as different channel feedback qualities.

Let the channel matrices Hₖ_{₁}, Hₖ_{₂} of user k₁, k₂ be decomposed into

Hₖ_{₁}=Uₖ_{₁}Λₖ_{₁}Vₖ_{₁}^{H} and Hₖ_{₂}=Uₖ_{₂}Λₖ_{₂}Vₖ_{₂}^{H}. (Equation 3)

In the case of perfect channel state information, the space-time-coded beamformer is reduced to a conventional beamformer. Accordingly, the receive-antenna weight vectors uₖ_{₁} and uₖ_{₂} are equal to the first column vectors of Uₖ_{₁} and Uₖ_{₂} . Channel correlation, which depends on the receive-antenna weight vectors, is defined by

ρₖ_{₁}_{,k}_{₂}=|uₖ_{₁}^{H}uₖ_{₂}|. (Equation 4)

Next, the conditions under which the users can be assigned to the same sub-carrier without interfering with each other are defined. The influence of ρ as defined by Equation 4 is examined.

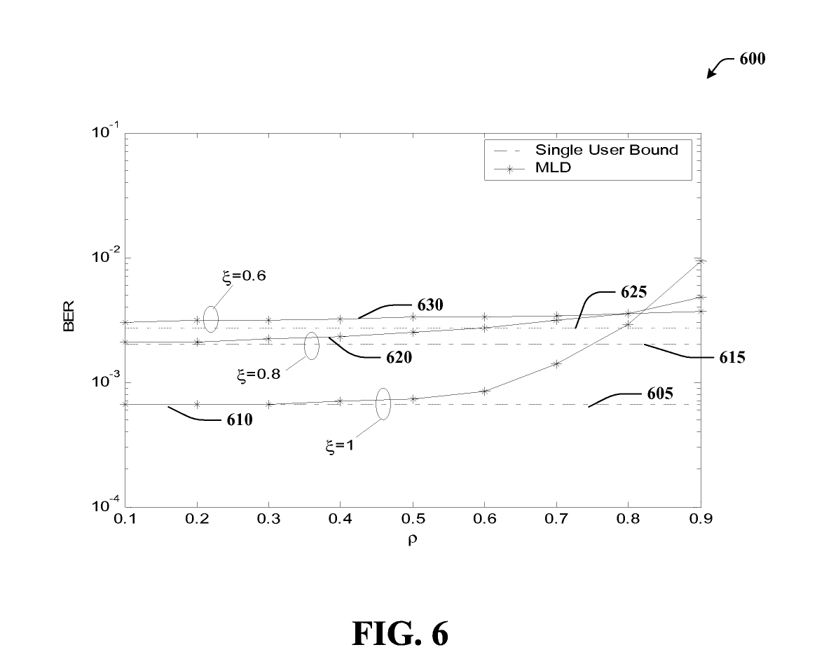

FIG. 6 presents the performance of the ML multiuser detection receiver as a function of ρ under different values of channel feedback quality ξ as defined in Equation 2. In particular, FIG. 6 illustrates a curve for single user bound and MLD at ξ=1 (605, 610), ξ−0.8 (615, 620), and ξ=0.6 (625, 630), respectively. The single user bit error rate (BER) bound increases when ξ decreases. On the other hand, the value of ρ has an important influence on the BER performance. Moreover, the range of ρ within which the BER using multiuser detection techniques is very close to the single user bound, becomes smaller as ξ decreases. However, the BER curves become smoother. Thus, in order to decide whether users can be assigned to the same sub-carrier or not, the values of both ξ and ρ can be considered. Let ξₜₕ and ρₜₕ denote two thresholds. Two users are admissible in the same subcarrier if ξ>ξₜₕ and ρ<ρₜₕ. Thus, when the channel feedback quality ξ is low, the correlation of the actual channels is not guaranteed given the outdated channel information.

The wireless network system can be considered to be interference-free as the assignment of sub-carriers is controlled so that the correlation between each pair of users is lower than the threshold ρₜₕ. The value of ρₜₕ is determined according to the channel feedback quality ξ as well as the multiuser detection architecture used at the receiver. Thus, the admissibility of each combination of users can be defined. Each combination corresponds to a subset of users. Hence, there are a total of 2^{K} possible combinations. For example, assume that K=4. A total of 16 combinations from (0,0,0,0) to (1,1,1,1) can be obtained. Each combination corresponds to a user set where the value 1 or 0 indicates whether a corresponding user is an element of such set or not. A combination is admissible if in the corresponding user subset, a pair of users cannot be found with a correlation higher than ρₜₕ. The channel feedback quality ξ is an indirect parameter for checking the admissible combinations and plays a role in determining the value of ρₜₕ. Specifically, 1_{i,n} is defined as the admissibility index for the ith combination on the nth sub-carrier. That is,

$${1}_{i , n} = \{ \begin{matrix}1 & i th combination is admissible on the n th subcarrier \\ 0 & else .\end{matrix} \qquad ( Equation 5 )$$

For example, consider a four-user scenario with ρₜₕ=0.5. If the correlation matrix on sub-carrier n is given by

$$ℵ = [ \begin{matrix}1 & 0.6 & 0.3 & 0.7 \\ 0.6 & 1 & 0.2 & 0.4 \\ 0.3 & 0.2 & 1 & 0.3 \\ 0.7 & 0.4 & 0.3 & 1\end{matrix} ] . \qquad ( Equation 6 )$$

1_{6,n}=1, which implies that the 6^{th} combination (0,1,0,1) which represents the set containing user 2 and user 4, is admissible. Likewise, 1_{12,n}=0 implies that the combination (1,0,1,1) is inadmissible, since user 1 and user 4 cannot be assigned to the same sub-carrier.

Allocation is determined by taking into consideration all admissible combinations of users. Assume that the AP successfully receives RTS packets from K users. The target can be to allocate the subcarriers, bits and power such that the data packets can be transmitted within a minimum airtime. Usually, minimizing the transmission time is equivalent to maximizing the data rate. From a physical layer point of view, the objective can be set to maximize the total data rate given the QoS requirements and total power constraint Pₜₒₜₐₗ. However, this may not be the case if issues in the upper layers of the network stack are considered. For example, different users can have packets with different lengths, which are determined by the characteristics of the applications. The data transmission time is dominated by the user which uses the maximum number of OFDM symbols. In such case, maximizing the total data rate does not reduce minimum airtime. As a result, an additional constraint is added such that the allocated data rates within each OFDM symbol are proportional to a users' packet length. Mathematically, an optimization problem can then be formulated as follows:

$$\begin{matrix}{max}_{{{β}_{i , n} ∈ [ 0 , 1 ]}_{{P}_{k , i , n} ∈ [ 0 , ∞ )}} {\sum }_{n = 1}^{N} {\sum }_{i = 1}^{{2}^{K}} {\sum }_{k = 1}^{K} {1}_{i , n} {β}_{i , n} {f}_{k , i , n} ( {P}_{k , i , n} ) \\ subject to \text{:} & ( Equation 7 A ) \\ {\sum }_{n = 1}^{N} {\sum }_{i = 1}^{{2}^{K}} {\sum }_{k = 1}^{K} {β}_{i , n} {P}_{k , i , n} = {P}_{total} , & ( Equation 7 B ) \\ {\sum }_{i = 1}^{{2}^{K}} {β}_{i , n} = 1 ∀ n , & ( Equation 7 C ) \\ \frac{{\sum }_{n = 1}^{N} {\sum }_{i = 1}^{{2}^{K}} {1}_{i , n} {β}_{i , n} {f}_{k , i , n} ( {P}_{k , i , n} )}{{\sum }_{n = 1}^{N} {\sum }_{i = 1}^{{2}^{K}} {1}_{i , n} {β}_{i , n} {f}_{k + 1 , i , n} ( {P}_{k + 1 , i , n} )} = \frac{{R}_{k}}{{R}_{k + 1}} \\ ∀ k = 1 , … , K - 1. & ( Equation 7 D )\end{matrix}$$

In order to limit the interference to other Basic Service Sets (BSSs) or neighboring systems, and compare different schemes under the same transmission power conditions, the total power constraint is given by Equation 7B. However, one will appreciate that it can be easily extended to the case of individual power constraints by applying a similar technique in the allocation technique. In the above equations, β_{i,n} denotes the packet length of user k and is defined as:

$${β}_{i , n} = \{ \begin{matrix}1 & {i}^{th} combination is chosen in subcarrier n \\ 0 & else .\end{matrix} \qquad ( Equation 8 )$$

In order to make the problem tractable, β_{i,n} can be relaxed to be a real number within the interval [0,1] in Equation 7A. The real-valued β_{i,n} can be interpreted as the time sharing factor for the ith combination on the nth sub-carrier. Specifically, if the number of OFDM symbols used to transmit the data frame is Nₛ, then the ith combination is assigned to the nth sub-carrier for a duration of Nₛβ_{i,n} OFDM symbols. For example, consider four users and the 1^{st} sub-carrier. The data frame contains Nₛ=40 OFDM symbols. Moreover, if the 4^{th} combination ((0,0,1,1), including user 3 and user 4) and the 13^{th} combination ((1,1,0,0), including user 1 and user 2) share this sub-carrier with β_{4,1}=0.4, and β_{13,1}=0.6, user 3 and user 4 will occupy this sub-carrier of the first 16 OFDM symbols while that of the remaining 24 OFDM symbols will be shared by user 1 and user 2. On the other hand, f_{k,i,n}(P_{k,i,n}) is the rate function for user k of the ith combination on sub-carrier n, given the allocated power P_{k,i,n}. Assume that adaptive M-QAM is used, then given the target bit error rate B̅E̅R̅ₜ̅ and the transmit power P, the number of bits that can be transmitted within each symbol is approximated as:

$${log}_{2} M = {log}_{2} ( 1 + \frac{1.5 \cdot P}{{d}_{0}^{2}} ) , \qquad ( Equation 9 )$$

where d₀² is calculated by

$${d}_{0}^{2} = [ \frac{{A}_{0} \cdot {( 5 {BER}_{0} )}^{\frac{- 1}{( {A}_{0} {N}_{r} )}}}{{\prod }_{μ = 1}^{2} {( 1 + {K}_{μ} )}^{\frac{{m}_{μ}}{{A}_{0}}}} - {B}_{o} ] \cdot \frac{{N}_{0}}{{σ}_{ɛ}^{2}} \\ where \\ {A}_{0} = {\sum }_{i = 1}^{2} {m}_{i} , {B}_{o} = {\sum }_{i = 1}^{2} \frac{{m}_{i}}{1 + {K}_{i}} \qquad$$

or if d₀² is not found with δ₂>0:

$${d}_{0}^{2} = \frac{{( 5 {BER}_{0} )}^{\frac{- 1}{( {m}_{1} {N}_{r} )}} - 1}{\frac{( 1 + {K}_{1} )}{{m}_{1}}} \cdot \frac{{N}_{0}}{{σ}_{ɛ}^{2}}$$

For brevity, let

$$γ = \frac{1.5}{{d}_{0}^{2}} . \qquad ( Equation 10 )$$

For a specific user k and sub-carrier n, γ_{k,n} represents the equivalent channel condition. Then, the rate function ∫_{k,i,n}(P_{k,i,n}) is obtained as

$${f}_{k , i , n} ( {P}_{k , i , n} ) = \{ \begin{matrix}{log}_{2} ( 1 + {γ}_{k , n} {P}_{k , i , n} ) & k ∈ {φ}_{i} \\ 0 & k ∉ {φ}_{i} ,\end{matrix} \\ where {φ}_{i} \qquad ( Equation 11 )$$

denotes the set of users contained in the ith combination. Both 1_{i,n} and ∫_{k,i,n}(P_{k,i,n}) depend on the transmitter and receiver structures.

The constraint in Equation 7D includes (K−1) independent equalities. Alternatively, this constraint can be replaced by K dependent inequalities since if a₁≦a₂≦ . . . ≦a_{K}≦a₁, it follows that a₁=a₂= . . . =a_{K}. That is,

$$\frac{{\sum }_{n = 1}^{N} {\sum }_{i = 1}^{{2}^{K}} {1}_{i , n} {β}_{i , n} {f}_{k , i , n} ( {P}_{k , i , n} )}{{\sum }_{n = 1}^{N} {\sum }_{i = 1}^{{2}^{K}} {1}_{i , n} {β}_{i , n} {f}_{{[ k + 1 ]}_{K} , i , n} ( {P}_{{[ k + 1 ]}_{K} , i , n} )} \leq \frac{{R}_{k}}{{R}_{{[ k + 1 ]}_{K}}} \\ k = 1 , … , K . \\ {Here [ \cdot ]}_{K} \qquad ( Equation 12 )$$

represents the modulus based on K with 1≦[•]_{K}<K. For example, [−1]_{K}=K−1, [0]_{K}=K, and [K+1]K=1.

∫_{k,i,n}(P_{k,i,n}) is a concave function. However, the objective function β_{i,n}∫_{k,i,n}(P_{k,i,n}) in Equation 7A may not be concave in (β_{i,n},P_{k,i,n}). Therefore, if c_{k,i,n}=P_{k,i,n}β_{i,n} Equations 7A-7D can be rewritten as:

$$\begin{matrix} {max}_{{{β}_{i , n} ∈ [ 0 , 1 ]}_{{c}_{k , i , n} ∈ [ 0 , ∞ )}} {\sum }_{n = 1}^{N} {\sum }_{i = 1}^{{2}^{K}} {\sum }_{k = 1}^{K} {1}_{i , n} {β}_{i , n} {f}_{k , i , n} ( \frac{{c}_{k , i , n}}{{β}_{i , n}} ) & ( Equation 13 A ) \\ subject to {\sum }_{n = 1}^{N} {\sum }_{i = 1}^{{2}^{K}} {\sum }_{k = 1}^{K} {c}_{k , i , n} = {P}_{total} , & ( Equation 13 B ) \\ {\sum }_{i = 1}^{{2}^{K}} {β}_{i , n} = 1 ∀ n , & ( Equation 13 C ) \\ \frac{{\sum }_{n = 1}^{N} {\sum }_{i = 1}^{{2}^{K}} {1}_{i , n} {β}_{i , n} {f}_{k , i , n} ( \frac{{c}_{k , i , n}}{{β}_{i , n}} )}{{\sum }_{n = 1}^{N} {\sum }_{i = 1}^{{2}^{K}} {1}_{i , n} {β}_{i , n} {f}_{{[ k + 1 ]}_{K} , i , n} ( \frac{{c}_{{[ k + 1 ]}_{K} , i , n }}{{β}_{i , n}} )} \leq \frac{{R}_{k}}{{R}_{{[ k + 1 ]}_{K}}} \\ k = 1 , … , K . & ( Equation 13 D )\end{matrix}$$

β_{i,n}∫_{k,i,n}(c_{k,i,n}/β_{i,n}) is concave within β_{i,n}ε[0,1] and c_{k,i,n}≧0. On the other hand, 1_{i,n} does not change the concavity of the objective function. The Lagrangian is obtained as

$$L = {\sum }_{n = 1}^{N} {\sum }_{i = 1}^{{2}^{K}} {\sum }_{k = 1}^{K} {1}_{i , n} {β}_{i , n} {f}_{k , i , n} ( \frac{{c}_{k , i , n}}{{β}_{i , n}} ) - λ ( {\sum }_{n = 1}^{N} {\sum }_{i = 1}^{{2}^{K}} {\sum }_{k = 1}^{K} {c}_{k , i , n} - {P}_{total} ) - {\sum }_{n = 1}^{N} {t}_{n} ( {\sum }_{i = 1}^{{2}^{K}} {β}_{i , n} - 1 ) - {\sum }_{k = 1}^{K} {u}_{k} [ ( {\sum }_{n = 1}^{N} {\sum }_{i = 1}^{{2}^{K}} {1}_{i , n} {β}_{i , n} {f}_{k , i , n} ( \frac{{c}_{k , i , n}}{{β}_{i , n}} ) ) \cdot {R}_{{[ k + 1 ]}_{K}} - ( {\sum }_{n = 1}^{N} {\sum }_{i = 1}^{{2}^{K}} {1}_{i , n} {β}_{i , n} {f}_{{[ k + 1 ]}_{K} , i , n} ( \frac{{c}_{{[ k + 1 ]}_{K} , i , n }}{{β}_{i , n}} ) ) \cdot {R}_{k} ] , \qquad ( Equation 14 )$$

where λ and tₙ are the Lagrange multipliers for Equations 13B and 13C, and uₖ are the Karush-Kuhn-Tucker (KKT) multipliers for Equation 13D, respectively. A set of KKT conditions for an optimal solution (c_{k,i,n}*,β_{i,n}) can then be obtained as follows:

$$\begin{matrix}If {β}_{i , n}^{*} \neq 0 , \\ \frac{\partial L}{\partial {c}_{k , i , n}} {\vert}_{( {c}_{k , i , n} , {β}_{i , n} ) = ( {c}_{k , i , n}^{*} , {β}_{i , n}^{*} )} = {1}_{i , n} {f}_{k , i , n}^{′} ( \frac{{c}_{k , i , n}^{*}}{{β}_{i , n}^{*}} ) - λ - {u}_{k} \cdot {1}_{i , n} \cdot {R}_{{[ k + 1 ]}_{K}} {f}_{k , i , n}^{′} ( \frac{{c}_{k , i , n}^{*}}{{β}_{i , n}^{*}} ) + {u}_{{[ k - 1 ]}_{K}} \cdot {1}_{i , n} \cdot {R}_{{[ k - 1 ]}_{K}} {f}_{k , i , n}^{′} ( \frac{{c}_{k , i , n}^{*}}{{β}_{i , n}^{*}} ) = {1}_{i , n} ( 1 - {u}_{k} {R}_{{[ k + 1 ]}_{K}} + {u}_{{[ k - 1 ]}_{K}} {R}_{{[ k - 1 ]}_{K}} ) {f}_{k , i , n}^{′} ( \frac{{c}_{k , i , n}^{*}}{{β}_{i , n}^{*}} ) - λ \{ \begin{matrix}< 0 & {c}_{k , i , n}^{*} = 0 \\ = 0 & {c}_{k , i , n}^{*} > 0 ,\end{matrix} \\ and & ( Equation 15 A ) \\ \frac{\partial L}{\partial {β}_{i , n}} {\vert}_{( {c}_{k , i , n} , {β}_{i , n} ) = ( {c}_{k , i , n}^{*} , {β}_{i , n}^{*} )} = {1}_{i , n} \cdot {\sum }_{k = 1}^{K} ( 1 - {u}_{k} {R}_{{[ k + 1 ]}_{K}} ) \\ [ {f}_{k , i , n} ( \frac{{c}_{k , i , n}^{*}}{{β}_{i , n}^{*}} ) - \frac{{c}_{k , i , n}^{*}}{{β}_{i , n}^{*}} {f}_{k , i , n}^{′} ( \frac{{c}_{k , i , n}^{*}}{{β}_{i , n}^{*}} ) ] + {1}_{i , n} \cdot {\sum }_{k = 1}^{K} {u}_{k} {R}_{k} [ {f}_{{[ k + 1 ]}_{K} , i , n} ( \frac{{c}_{{[ k + 1 ]}_{K} , i , n}^{*}}{{β}_{i , n}^{*}} ) - \frac{{c}_{{[ k + 1 ]}_{K} , i , n}^{*}}{{β}_{i , n}^{*}} {f}_{{[ k + 1 ]}_{K} , i , n}^{′} ( \frac{{c}_{{[ k + 1 ]}_{K} , i , n}^{*}}{{β}_{i , n}^{*}} ) ] - {t}_{n} \{ \begin{matrix}> 0 & {β}_{i , n}^{*} = 1 \\ = 0 & {β}_{i , n}^{*} ∈ ( 0 , 1 ) .\end{matrix} & ( Equation 15 B )\end{matrix}$$

Otherwise, if β_{i,n}*=0, then

$${c}_{k , i , n} \frac{\partial L}{\partial {c}_{k , i , n}} + {β}_{i , n} \frac{\partial L}{\partial {β}_{i , n}} \leq 0 \\ for all {β}_{i , n} ∈ ( 0 , 1 ] and {c}_{k , i , n} > 0. \qquad ( Equation 15 C )$$

Moreover the other KKT conditions include

$$\begin{matrix}{\sum }_{k = 1}^{K} {u}_{k} [ ( {\sum }_{n = 1}^{N} {\sum }_{i = 1}^{{2}^{K}} {1}_{i , n} {β}_{i , n} {f}_{k , i , n} ( \frac{{c}_{k , i , n}}{{β}_{i , n}} ) ) \cdot {R}_{{[ k + 1 ]}_{K}} - ( {\sum }_{n = 1}^{N} {\sum }_{i = 1}^{{2}^{K}} {1}_{i , n} {β}_{i , n} {f}_{{[ k + 1 ]}_{K} , i , n} ( \frac{{c}_{{[ k + 1 ]}_{K} , i , n}}{{β}_{i , n}} ) ) \cdot {R}_{k} ] = 0 & ( Equation 15 D ) \\ {u}_{k} \geq 0 , k = 1 , … , K , & ( Equation 15 E )\end{matrix}$$

as well as the constraints expressed in Equations 13B-13D.

When 1_{i,n}=0,

β_{i,n}=0 and c_{k,i,n}*=0, ∀k. (Equation 16)

When 1_{i,n}=1, using Equations 15A and 15C

$$\begin{matrix}{c}_{k , i , n}^{*} = {β}_{i , n}^{*} {f}_{k , i , n}^{′ - 1} ( \frac{{λ}_{0}}{1 - {u}_{k} {R}_{{[ k + 1 ]}_{K}} + {u}_{{[ k - 1 ]}_{K}} {R}_{{[ k - 1 ]}_{K}}} ) , \\ where & ( Equation 17 ) \\ {λ}_{0} = \{ \begin{matrix}( 1 - {u}_{k} {R}_{{[ k + 1 ]}_{K}} + {u}_{{[ k - 1 ]}_{K}} {R}_{{[ k - 1 ]}_{K}} ) {f}_{k , i , n}^{′} ( 0 ) & {f}_{k , i , n}^{′ - 1} ( \frac{λ}{1 - {u}_{k} {R}_{{[ k + 1 ]}_{K}} + {u}_{{[ k - 1 ]}_{K}} {R}_{{[ k - 1 ]}_{K}}} ) < 0 \\ λ & {f}_{k , i , n}^{′ - 1} ( \frac{λ}{1 - {u}_{k} {R}_{{[ k + 1 ]}_{K}} + {u}_{{[ k - 1 ]}_{K}} {R}_{{[ k - 1 ]}_{K}}} ) \geq 0.\end{matrix} & ( Equation 18 )\end{matrix}$$

On the other hand, it follows from Equations 15B and 15C that

$$\begin{matrix} {β}_{i , n}^{*} = \{ \begin{matrix}0 & {t}_{n} > {G}_{i , n} ( {λ}_{0} ) \\ 1 & {t}_{n} < {G}_{i , n} ( {λ}_{0} ) ,\end{matrix} \\ where & ( Equation 19 ) \\ {G}_{i , n} ( {λ}_{0} ) = {\sum }_{k ∈ {φ}_{i}} {Q}_{k , i , n} ( {λ}_{0} ) \\ and & ( Equation 20 ) \\ {Q}_{k , i , n} ( {λ}_{0} ) = ( 1 - {u}_{k} {R}_{{[ k + 1 ]}_{K}} + {u}_{{[ k - 1 ]}_{K}} {R}_{{[ k - 1 ]}_{K}} ) \cdot \\ [ {f}_{k , i , n} ( {f}_{k , i , n}^{′ - 1} ( \frac{{λ}_{0}}{1 - {u}_{k} {R}_{{[ k + 1 ]}_{K}} + {u}_{{[ k - 1 ]}_{K}} {R}_{{[ k - 1 ]}_{K}}} ) ) - {f}_{k , i , n}^{′ - 1} ( \frac{{λ}_{0}}{1 - {u}_{k} {R}_{{[ k + 1 ]}_{K}} + {u}_{{[ k - 1 ]}_{K}} {R}_{{[ k - 1 ]}_{K}}} ) \cdot \frac{{λ}_{0}}{1 - {u}_{k} {R}_{{[ k + 1 ]}_{K}} + {u}_{{[ k - 1 ]}_{K}} {R}_{{[ k - 1 ]}_{K}}} ] . & ( Equation 21 )\end{matrix}$$

In order to satisfy the constraint of Equation 13C,

$$\begin{matrix}{β}_{i , n}^{*} = 1 and {β}_{i , n}^{*} = 0 for all i \neq {i}^{′} , \\ where & ( Equation 22 ) \\ {i}^{′} = {arg max}_{i ∈ {ψ}_{n}} {G}_{i , n} ( {λ}_{0} ) , {ψ}_{n} = \{ i \text{:} {arg}_{i} {1}_{i , n} = 1 \} . & ( Equation 23 )\end{matrix}$$

Here ψₙ denotes the set of admissible combinations in the nth sub-carrier.

Given the values of (λ,u₁,u₂, . . . ,u_{K}), an optimal solutions can be obtained of (c_{k,i,n}*,β_{i,n}). However, the values of (λ,u₁,u₂, . . . , u_{K}) are adjusted in order to satisfy the KKT conditions of Equations 13B, 13D, 15D and 15E.

Thus, an iterative technique according to one embodiment obtains the values of (λ,u₁,u₂, . . . ,u_{K}) as follows:

Step 1: Initialize the KKT multipliers u₁=u₂= . . . =u_{K}=0 and λ to be a very small values.

Step 2: Based on the current values of (λ,u₁,u₂, . . . ,u_{K}), compute the temporarily optimal solutions of (c_{k,i,n}*,β_{i,n}) using Equations 16-23.

Step 3: Examine whether the KKT condition based on Equation 13B is satisfied or not. If yes, go to the next step. If not, adjust the value of λ and repeat Step 2 using the updated value of λ, until the total power constraint in Equation 13B is satisfied.

Step 4: Examine whether the KKT conditions based on Equations 13D, 15D and 15E are all satisfied. If so, stop.

If one or more conditions are not satisfied, iteratively search the values of (u₁,u₂, . . . ,u_{K}).

In each iteration, choose the user k^{∘} satisfying

$$\begin{matrix} {k}^{∘} = {arg max}_{k} {E}_{k}^{+} \\ where & ( Equation 24 ) \\ {E}_{k}^{+} = max ( 0 , {E}_{k} ) = \{ \begin{matrix}0 & if {E}_{k} \leq 0 \\ {E}_{k} & if {E}_{k} > 0\end{matrix} \\ and & ( Equation 25 ) \\ {E}_{k} = \frac{{\sum }_{n = 1}^{N} {\sum }_{i = 1}^{{2}^{K}} {1}_{i , n} {β}_{i , n} {f}_{k , i , n} ( \frac{{c}_{k , i , n}}{{β}_{i , n}} )}{{R}_{k}} - \frac{{\sum }_{n = 1}^{N} {\sum }_{i = 1}^{{2}^{K}} {1}_{i , n} {β}_{i , n} {f}_{{[ k + 1 ]}_{K} , i , n} ( \frac{{c}_{{[ k + 1 ]}_{K} , i , n}}{{β}_{i , n}} )}{{R}_{{[ k + 1 ]}_{K}}} & ( Equation 26 )\end{matrix}$$

Search the value of uₖ_{^{∘}} using the bi-section method in order to make Eₖ^{_{si ∘}}=0. Specifically, set the initial lower bound uₖ_{^{∘}}^{(l)} to be the current value uₖ_{^{∘}} and the initial upper bound

$${u}_{{k}^{∘}}^{( u )} = \frac{1 - ( λ \cdot ln 2 / {γ}_{{k}^{∘}}^{max} ) + {u}_{{[ {k}^{∘} - 1 ]}_{K}} {R}_{{[ {k}^{∘} - 1 ]}_{K}}}{{R}_{{[ {k}^{∘} + 1 ]}_{K}}} \\ where \\ {γ}_{{k}^{∘}}^{max} = {max}_{∀ n} {γ}_{{k}^{∘} , n} , \qquad ( Equation 27 )$$

which denotes the best channel gain for user k^{∘} among all the subcarriers.

The initial upper bound uₖ_{^{∘}}^{(u)} is set so that c_{k,i,n}*=0 for all n. In such case, Eₖ_{^{∘}}<0. As a result, the correct value of uₖ_{^{∘}} which results in Eₖ_{^{∘}}=0 should be between uₖ_{^{∘}}^{(l)} and uₖ_{^{∘}}^{(u)}.

$$Set {u}_{{k}^{∘}}^{( m )} = \frac{( {u}_{{k}^{∘}}^{( l )} + {u}_{{k}^{∘}}^{( u )} )}{2}$$

and repeat Step 2 using uₖ_{^{∘}}^{(m)}.

If Eₖ_{^{∘}}>0, set

uₖ_{^{∘}}^{(l)}=uₖ_{^{∘}}^{(m)}. (Equation 28)

Else, if Eₖ_{^{∘}}<0, set

uₖ_{^{∘}}^{(u)}=uₖ_{^{∘}}^{(m)}. (Equation 29)

Repeat the bi-section search procedure until Eₖ_{^{∘}}=0.

Switch to another user according to Equation 24, and repeat the iterative procedure until the KKT conditions in Equations 13D, 15D and 15E are all satisfied.

Step 5: Repeat Step 3 and Step 4.

The bi-section search procedure of Step 4 can happen when a value of uₖ_{^{∘}} to satisfy the condition Eₖ_{^{∘}}=0 is not found. The searching can then oscillate between the two cases Eₖ_{^{∘}}<0 and Eₖ_{^{∘}}>0 because the two combinations can alternatively occupy the same sub-carrier. Thus, the two combinations have the same values of G (see Equation 20) on this sub-carrier given the critical value of uₖ_{^{∘}}. In such a case, the sharing factor β_{i,n} can be used to take values within the interval (0,1). Specifically, it is assumed that there are two combinations i₁ and i₂, sharing the same sub-carrier n^{∘}. If only the combination i₁ is chosen, the resultant total rates per OFDM symbol for user k^{∘} and user [k^{∘}+1]_{K} are denoted as Sₖ_{^{∘}} and

$${S}_{{[ {k}^{∘} + 1 ]}_{K}} ,$$

respectively. Alternatively, if only the combination i₂ is chosen, the resultant total rates per OFDM symbol are changed to S′ₖ_{^{∘}} and

$${S}_{{[ {k}^{∘} + 1 ]}_{K}}^{′} .$$

Then, the sharing factors for the two combinations can be obtained as follows:

$$\begin{matrix}{β}_{{i}_{1} , {n}^{∘}} = \frac{{R}_{{k}^{∘}} {S}_{{[ {k}^{∘} + 1 ]}_{K}}^{′} - {R}_{{[ {k}^{∘} + 1 ]}_{K}} {S}_{{k}^{∘}}^{′}}{{R}_{{[ {k}^{∘} + 1 ]}_{K}} ( {S}_{{k}^{∘}} - {S}_{{k}^{∘}}^{′} ) - {R}_{{k}^{∘}} ( {S}_{{[ {k}^{∘} + 1 ]}_{K}} - {S}_{{[ {k}^{∘} + 1 ]}_{K}}^{′} )} \\ and & ( Equation 30 ) \\ {β}_{{i}_{2} , {n}^{∘}} = \frac{{R}_{{[ {k}^{∘} + 1 ]}_{K}} {S}_{{k}^{∘}} - {R}_{{k}^{∘}} {S}_{{[ {k}^{∘} + 1 ]}_{K}}}{{R}_{{[ {k}^{∘} + 1 ]}_{K}} ( {S}_{{k}^{∘}} - {S}_{{k}^{∘}}^{′} ) - {R}_{{k}^{∘}} ( {S}_{{[ {k}^{∘} + 1 ]}_{K}} - {S}_{{[ {k}^{∘} + 1 ]}_{K}}^{′} )} . & ( Equation 31 )\end{matrix}$$

An OFDM system is simulated with 64 sub-carriers over a 20 MHz band. The wireless channels are modeled as six-path Rayleigh fading channels with an exponential power delay profile and a root mean square (RMS) delay spread of 300 ns. In this simulation, the number of transmit antennas Mₜ equipped at each mobile is assumed to be equal to 2 and that the number of receive antennas Mᵣ is 4 at the AP. A target B̅E̅R̅ₜ̅ of 10⁻⁶ is chosen to maintain a low probability of packet error and retransmission. The feedback quality ξ (as defined in Equation 2), which is determined by the normalized Doppler frequency, is usually 0.8 or higher. As a result, ξ is assumed to be 0.8 (∫_{d}t_{Δ}=0.15) at the transmitters and correspondingly ρₜₕ=0.4 is set for the simulations. Likewise, the packet length (including the payload and media access control header) is uniformly distributed between 100 bytes and 1000 bytes.

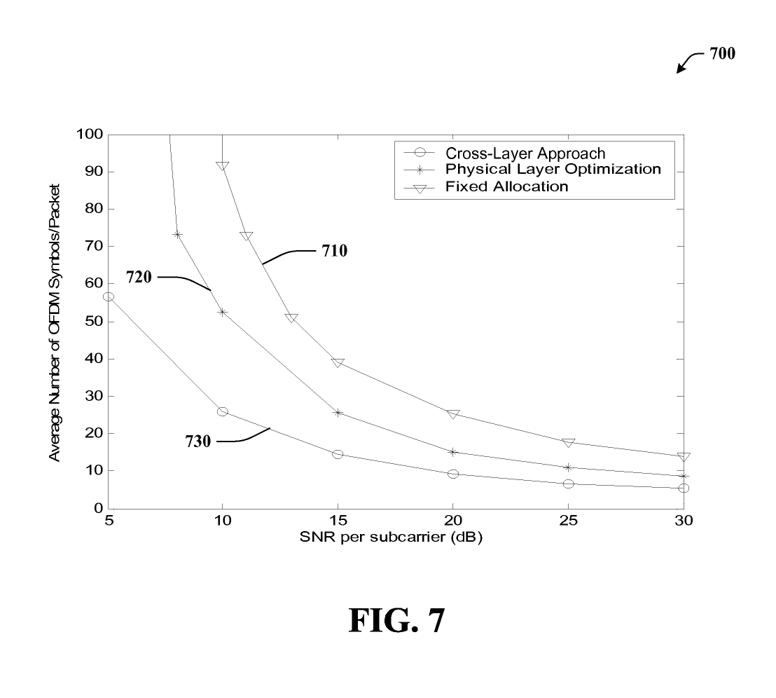

In FIG. 7, the average number of OFDM symbols per packet is illustrated for the cross-layer scheme over two other schemes. In particular, FIG. 7 illustrates a curve for the cross-layer approach 730, physical layer optimization 720 and fixed allocation 710. A scenario with four users is simulated. The first scheme used for comparison is one that maximizes the raw data rate from a physical-layer point of view, but without the consideration of packet issues in the upper layers (e.g., without the constraint of Equation 7D from the original problem). This scheme is referred to as Physical-Layer Optimization. The second one is referred to as Fixed Allocation, which adopts frequency-division multiple access (FDMA) and fixed modulation based on conventional beamforming. Conventional beamforming can be obtained by setting δ₁=1 and δ₂=0. On the other hand, the number of OFDM symbols per packet is defined as the number of OFDM symbols used for data transmission divided by the number of packets contained in this data frame.

Recall that the duration of each data frame is determined by the user. A four-user case is considered. The transmit signal-to-noise ratio (SNR) per sub-carrier is defined as SNR=P_{Total}/(N·N₀) where N₀ denotes the noise power. Without loss of generality, N₀=1 in this simulation. From this figure, it can be easily seen that the number of OFDM symbols used by the cross-layer approach is much less than that of the other two schemes throughout the range of SNR considered. Thus, the cross-layer approach can always achieve a throughput improvement and more efficiently utilize the resources. Using Fixed Allocation or Physical-Layer Optimization, the number of OFDM symbols used can increase to infinity in the low SNR region because fixed allocation is typically inefficient, which may result in zero allocation with a low total power budget. While in the case of Physical-Layer Optimization, some users with bad channel conditions may be turned off so as to maximize the sum of all users' data rates. As a result, the number of OFDM symbols is dominated by these turned-off users and consequently will tend to approach infinity. Thus, the optimization within a single layer may not be efficient. In contrast, more advantages can be exploited through a cross-layer approach.

The throughput performance for different schemes is investigated by simulation and/or experiments. For the purpose of these simulations/experiments, Rayleigh fading is assumed to be quasi-stationary within each data frame and independent between different data frames. A system with 20 Kₜ users is used and the maximum number of users which can be supported simultaneously is Kₘₐₓ=Mᵣ=4. Saturated traffic is also assumed. In the backoff procedure, CWₘᵢₙ equals 8 and CWₘₐₓ equals 256, respectively.

In one embodiment, the formats of the control frames including the RTS, CTS, ACK are designed based on the current 802.1 a standard, which are composed of a Frame Control Field (2 bytes), Duration Field (2 bytes), Receiver Address (RA) Field (6 bytes), Transmitter Address (TA) Field (6 bytes, only in the RTS), and Frame Check Sequence (FCS, 4 bytes). However, one will appreciate that other formats can be used for control frames. Because MPR is supported, multiple RA Fields can be required for the CTS and ACK frames to acknowledge the nodes with successful RTS requests or data transmissions. All the control frames can be transmitted at the same rate (e.g., 6 Mbps) or at variable rates. The other parameters used in this simulation are listed in Table 1. However, one will realize that the parameters are merely exemplary and other parameter values can be used in other embodiments.

TABLE 1

| | |
|---|---|
| SLOT | 9 us |
| SIFS | 16 us |
| DIFS | 34 us |
| PHY Header | 20 us |
| OFDM Symbol Duration | 4 us |
| CTSₜᵢₘₑₒᵤₜ | 300 us |
| ACKₜᵢₘₑₒᵤₜ | 300 us |

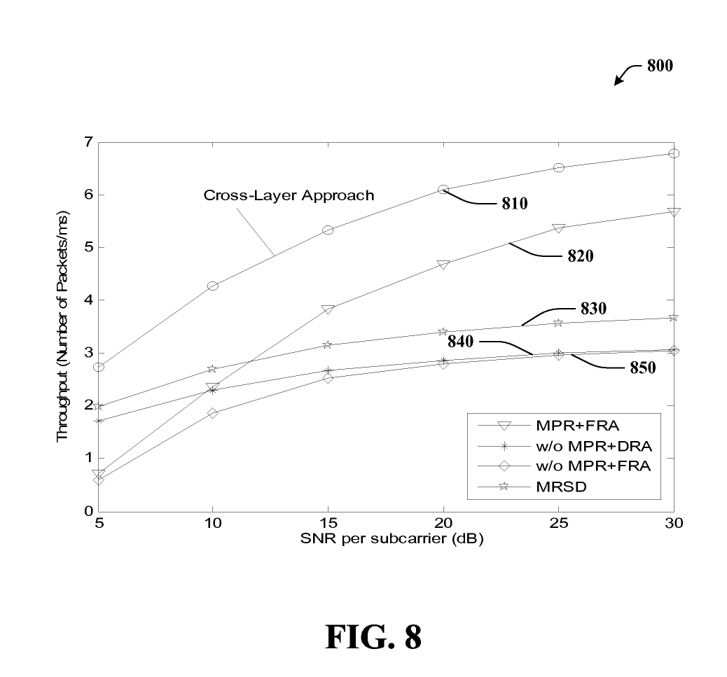

In contrast to the cross-layer approach where MPR and adaptive resource allocation are jointly designed, either no MPR or no adaptive resource allocation is applied in classical wireless systems. These previous methods are referred to as MPR+fixed resource allocation (FRA), without MPR+dynamic resource allocation (DRA), and without MPR+FRA, respectively. Another scheme used for comparisons is the one where the AP detects multiple RTS packets but sends CTS to only one user with adaptive resource allocation. This scheme is referred to as Multiple RTS Reception with Single Data Packet Transmission (MRSD). FIG. 8 demonstrates the average throughput achieved by different techniques, as the SNR increases from 5 dB to 30 dB. In particular, FIG. 8 illustrates a curve for the cross-layer approach 810, MPR+FRA 820, MRSD 830, without MPR+DRA 840 and without MPR+FRA 850. A data packet is defined to be successfully received if all the bits in this packet are correctly decoded.

The average throughput is then defined as the average number of packets which are successfully received within a time unit (e.g., ms). An uncoded system is assumed for this simulation. The cross-layer approach can achieve significant improvement on average throughput compared with the other schemes. Moreover, MPR+FRA outperforms MRSD and without MPR+DRA in most cases, except in the low SNR range. Thus, MPR plays a more important role compared to DRA as SNR increases, because the overhead required for the channel access contention can be considerably reduced by scheduling multiple users at a time. A close observation of this figure further illustrates that the average throughput of without MPR schemes appears more stable with respect to different SNRs, compared to the schemes using MPR. On the other hand, the throughput gap between the w/o MPR+DRA and w/o MPR+FRA schemes becomes narrow in the high SNR range.

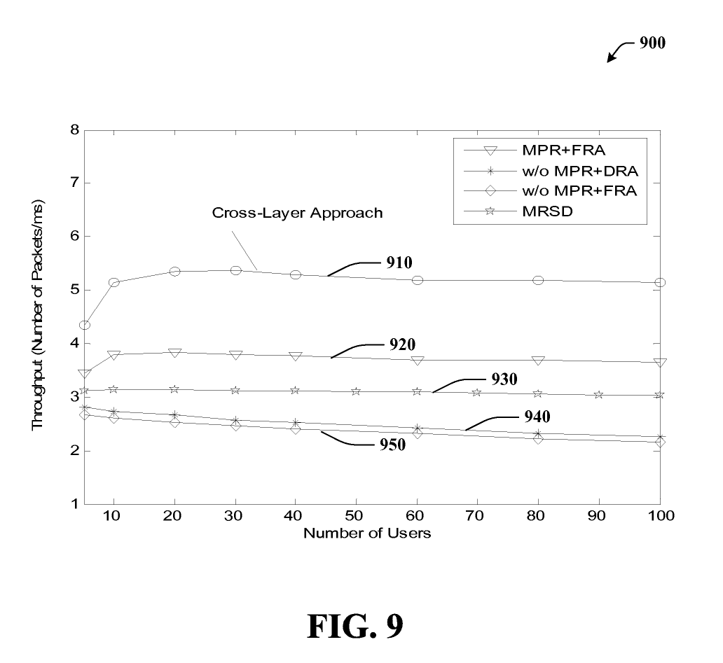

In the above experiment, a system with 20 Kₜ users was used. A simulation was conducted to determine the performance of the schemes under different network sizes. FIG. 9 compares the average throughput of different schemes, as the number of users in the network increases from 5 to 100. An SNR of 15 dB is assumed for the simulation. FIG. 9 illustrates curves for the cross-layer approach 910, MPR+FRA 920, MRSD 930, without MPR+DRA 940 and without MPR+FRA 950. The cross-layer approach can outperforms the other schemes for both small-size and large-size systems. In addition, the without MPR+FRA method has a very similar performance as without MPR+DRA, which is monotonically decreasing along with the increase of the users' number Kₜ. In particular for these schemes, when the number of users contending for access increases, more collisions occur; hence, more resources will be wasted.

In contrast, the peak throughput of the cross-layer approach or the MPR+FRA scheme is not achieved at the point of minimum network size. Specifically, a throughput increase is shown from Kₜ=5 to Kₜ=30 using the cross-layer approach since resources are efficiently utilized and multiuser diversity is not fully exploited when the number of users is relatively small. Thus, the number of users corresponding to the maximum throughput in the cross-layer approach is larger than that of the MPR+FRA scheme. On the other hand, the throughput of MRSD remains basically unchanged with respect to different numbers of users since no multi-user diversity gain can be utilized and the use of multiple RTS reception control can reduce collisions when the number of users increases.

In the experiments described so far, saturated traffic in the network is assumed. However, it is more practical to make a common assumption on the traffic arrival mode. In this sub-section, packets are generated for the queue of user j according to a Poisson distribution of parameter rⱼ. Thus, the time interval between two successive packets' arrival obeys an exponential distribution. rⱼ is the intensity of the arrivals or the packet arrival rate within a unit time. The packet arrival processes for Kₜ users are assumed to be independent and the network capacity is denoted by η. In particular,

$${\sum }_{j = 1}^{{K}_{t}} {r}_{j}$$

should be no larger than η so as to make the system stable or in equilibrium.

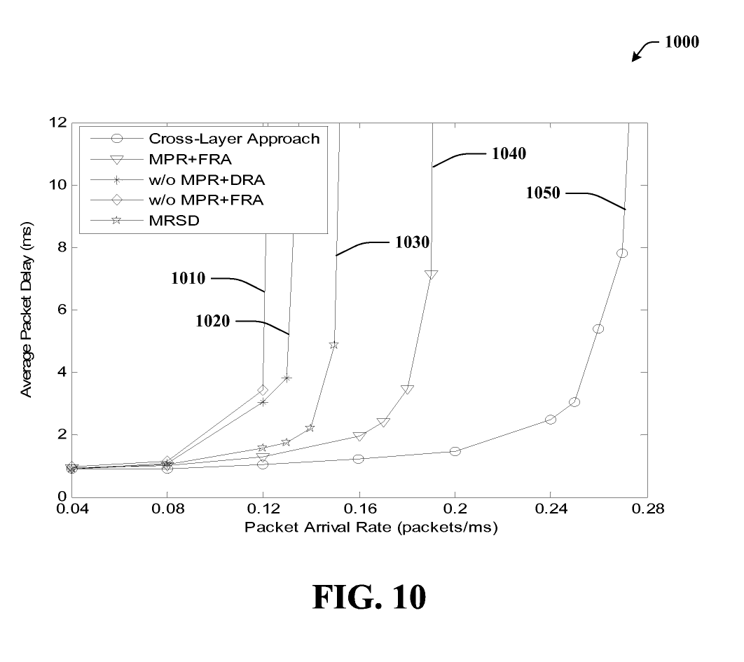

FIG. 10 illustrates the average packet delay under different packet arrival rates. The packet delay is defined as the time interval from the time the packet arrives, until an ACK for this packet is receiver. In particular, FIG. 10 illustrates packet delay when SNR=15 dB and Kₜ=20. FIG. 10 illustrates curves for the cross-layer approach 1050, MPR+FRA 1040, MRSD 1030, without MPR+DRA 1020 and without MPR+FRA 1010. Without loss of generality, the packet arrival rate, denoted as r, is assumed to be the same for all users. Using, MPR+FDA, the system becomes unstable (e.g., the average packet delay grows unboundedly with time) when r is larger than 0.18 packets/ms. The performance of MRSD, without MPR+DRA and without MPR+FRA is even worse, which results in an infinite packet delay unless the packet arrival rate is lower than 0.15 packets/ms, 0.13 packets/ms, and 0.12 packets/ms, respectively. In contrast, the average packet delay using a cross-layer approach is significantly lower than that of the other schemes at heavy traffic loads. Specifically, when the packets arrive at a rate of 0.18 packets/ms, the technique can achieve a delay reduction of 60% compared to MPR+FRA. In addition, the system can be kept stable, as long as the packet arrival rate does not exceed 0.26 packets/ms. Moreover, it follows from the results illustrated in FIG. 8 that the network capacity η using the technique is about 5.2 packets/ms at an SNR of 15 dB. Hence, this verifies the theory that the system is stable when the accumulated packet arrival rate Kₜ·r is smaller than the network capacity η. On the other hand, as the traffic load decreases, the gap of packet delay between different schemes gradually diminishes and finally vanishes.

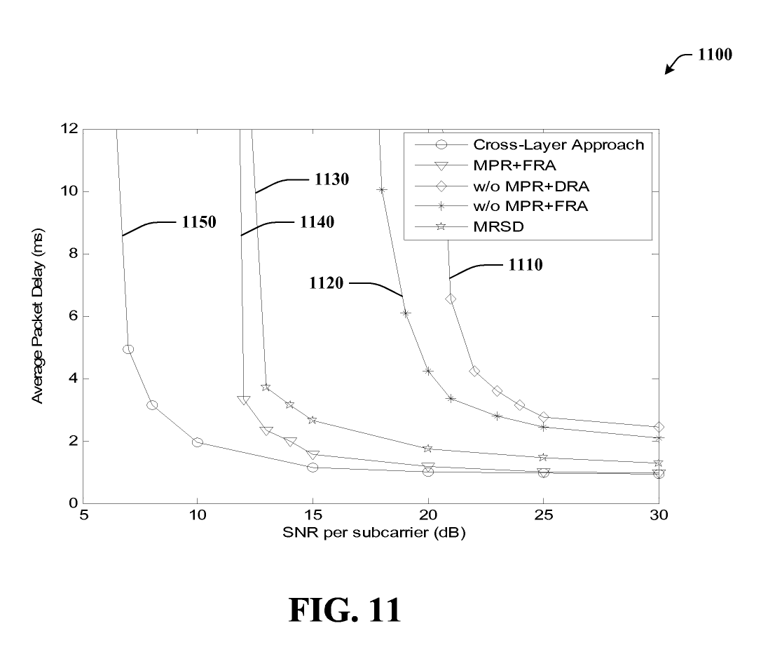

The average packet delay of these schemes is determined given different values of SNR. FIG. 11 illustrates the comparison of the average packet delay assuming that a packet arrival rate r=0.14 packets/ms and Kₜ=20. In particular, FIG. 11 illustrates curves for the cross-layer approach 1150, MPR+FRA 1140, MRSD 1130, without MPR+DRA 1110 and without MPR+FRA 1120. As expected, the average packet delay decreases as SNR increases, and the cross-layer approach significantly outperforms other schemes throughout the whole SNR range. In order to make the system stable, an SNR advantage of 5 dB, 6 dB, 11 dB, 14 dB can be gained by the cross-layer approach, compared to MPR+FRA, MRSD, without MPR+DRA, without MPR+FDA, respectively. Furthermore, it can be seen that unlike FIG. 9 where the gap of packet delay diminishes for the light traffic load, the delay performance of the different schemes does not converge even for high SNR. This is because, compared to the without MPR schemes, MPR can greatly reduce the probability of collisions and improve the packet delay when the traffic load is not so light.

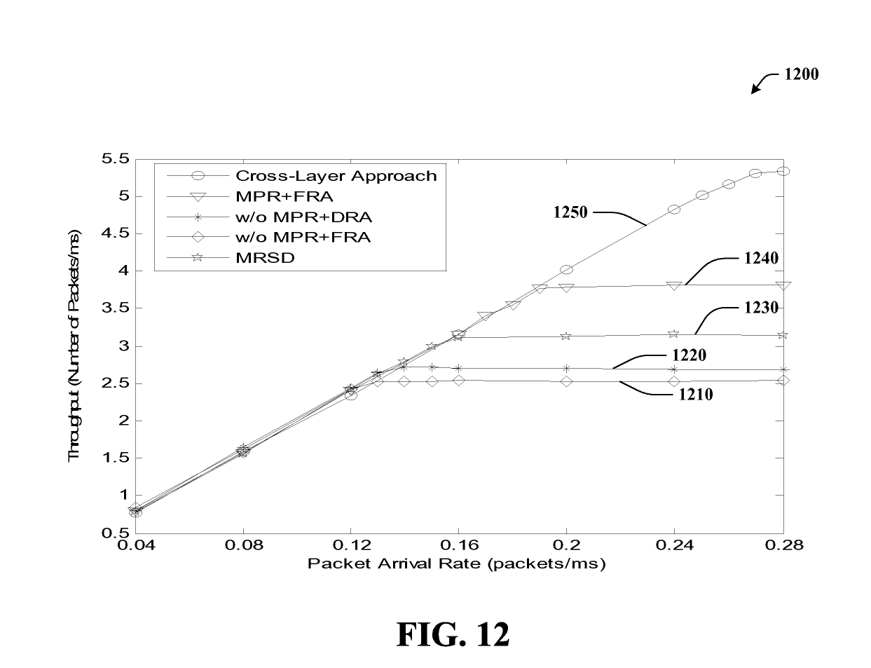

The throughput performance of different schemes under different packet arrival rates is illustrated in FIG. 12. In particular, FIG. 12 illustrates curves for the cross-layer approach 1250, MPR+FRA 1240, MRSD 1230, without MPR+DRA 1220 and without MPR+FRA 1210. Each scheme has a threshold of packet arrival rate which has an important influence on the system throughput. When the packet arrival rate is lower than such threshold, the throughput linearly increases as the packet arrival rate increases. Otherwise, the throughput remains basically unchanged. This phenomenon can be easily understood and these thresholds can be obtained from FIG. 10 where the system becomes unstable and packet delay tends to infinity at these critical points. Alternatively, these thresholds can be determined using the network capacity (e.g., the maximum system throughput which is achieved in saturation condition) divided by the number of users.

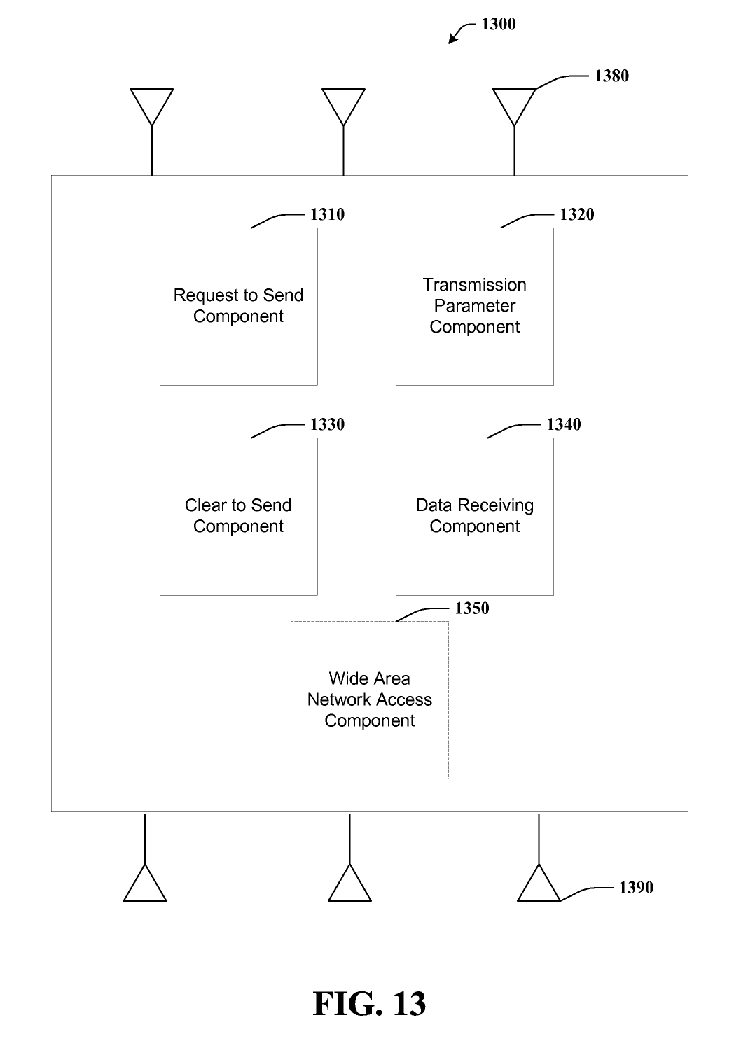

Referring to FIG. 13, an exemplary system at a receiver according to one embodiment is illustrated. In this example, the receiver has multiple receiving antennas 1380 as well as multiple transmitting antennas. The system has various components that can be implemented in hardware or software. In this illustrated system, there are five components: a request to send component 1310, a transmission parameter component 1320, a clear to send component 1330, a data receiving component 1340, and a wide are network access component 1350.

The request to send component 1310 receives a request to send packet from a transmitter, the packet includes channel state information. The transmission parameter component 1320 determines transmission parameters to minimize airtime based at least in part on channel state information supplied in the request to send. The clear to send component 1330 generates a clear to send packet with the determined transmission parameters and transmits it to the transmitter that made the request to send. The data receiving component decodes data received from multiple transmitters using the transmission parameters. Some of the decoded data can be transmitted via the wide area network access component 1350 to communicate the data to a wide area network, such as the Internet.

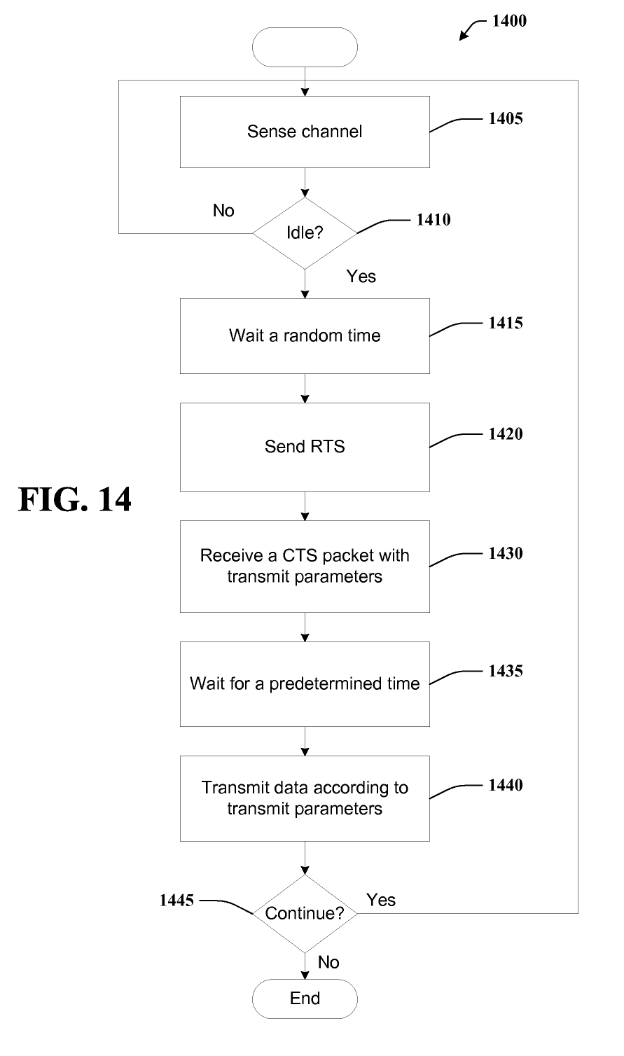

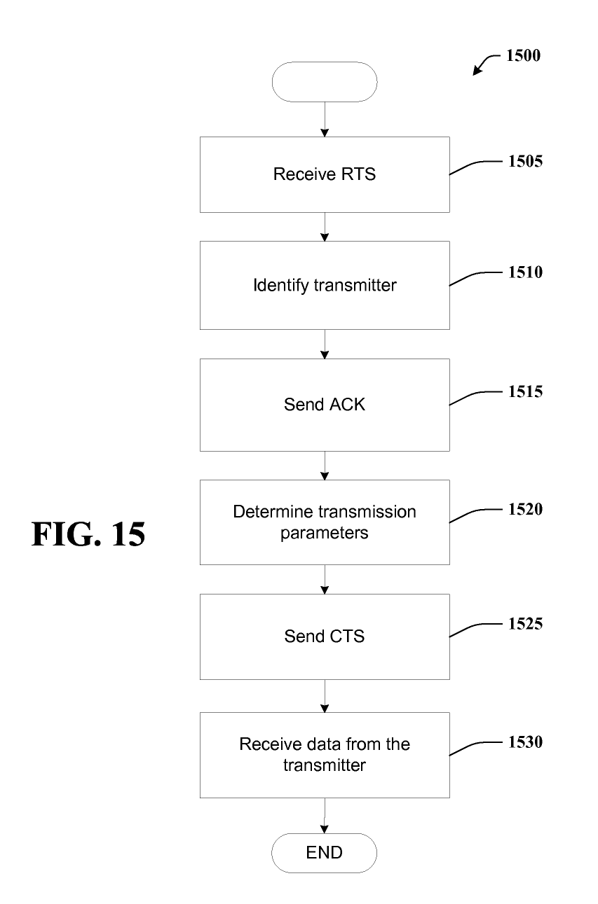

In view of the exemplary systems described supra, methodologies that may be implemented in accordance with the disclosed subject matter will be better appreciated with reference to the flowcharts of FIGS. 14 and 15. While for purposes of simplicity of explanation, the methodologies are shown and described as a series of blocks, it is to be understood and appreciated that the claimed subject matter is not limited by the order of the blocks, as some blocks can occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Referring to FIG. 14, a method 1400 of a user device transmitter is illustrated. At 1405, the channel is sensed to determine if the channel is free. When the channel is idle 1410, the transmitter waits a random time not to exceed the contention period at 1415. One will appreciate that the random time can be a pseudorandom time. At 1420, a request to send (RTS) frame is sent to the receiver. The frame includes address information as well as channel state information. If a collision occurs, the contention period is doubled and actions 1415 and 1420 are repeated. Eventually, at 1430, a clear to send frame is received from a receiver with transmission parameters. At 1440, data is transmitted in accordance with the transmit parameters. At 1445, the method can continue to allow transmission of additional data.

Referring to FIG. 15, a method 1500 of a receiver is illustrated. For the sake of brevity and clarity, the method is illustrated for communications with a single transmitter; however, one will appreciate that the receiver is interacting with multiple transmitters concurrently.

At 1505, a request to send (RTS) frame is received. The RTS packet comprises channel state information as well as address information. At 1510, the transmitter is identified, such as by using the address information in the RTS packet. At 1515, an acknowledgment (ACK) is transmitted to the identified transmitter. At 1520, the transmission parameters are determined so as to efficiently use the physical layer, such as by performing steps 1-5, supra. At 1525, a clear to send (CTS) frame is sent with the determined transmission parameters. At 1530, data is received from the transmitter.

### Exemplary User Device

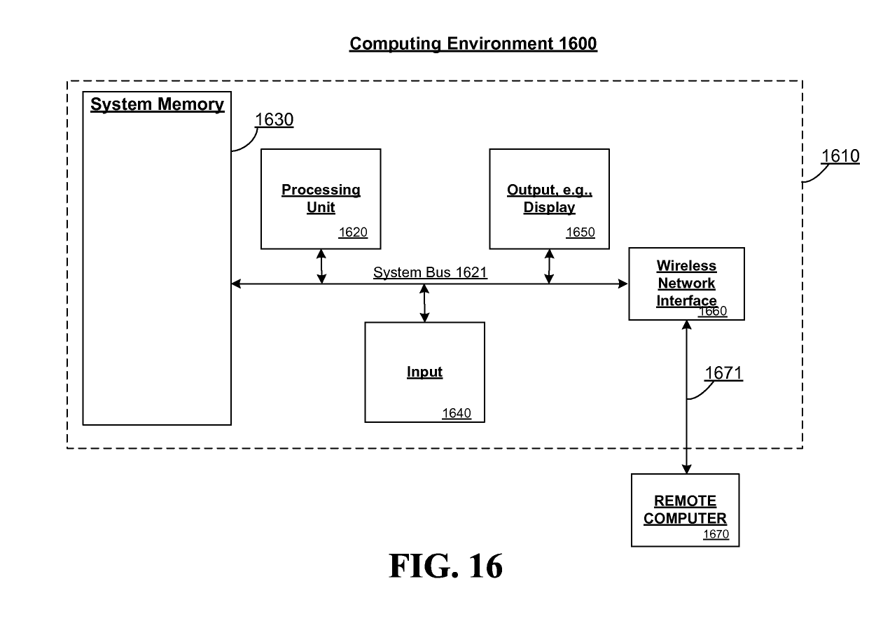

As mentioned, the invention applies to any device wherein it may be desirable to act as a transmitter or receiver in a wireless network, wherein the transmitter or receiver has multiple antennas. It should be understood, therefore, that handheld, portable and other computing devices and computing objects of all kinds are contemplated for use in connection with the present invention, i.e., anywhere that a wireless device may be useful to receive, process or store data. Accordingly, the below general purpose user device described below in FIG. 16 is but one example, and the present invention may be implemented with any computing device having wireless network interoperability and interaction.

FIG. 16 thus illustrates an example of a suitable computing system environment 1600 in which the invention may be implemented, although as made clear above, the computing system environment 1600 is only one example of a suitable computing environment and is not intended to suggest any limitation as to the scope of use or functionality of the invention. Neither should the computing environment 1600 be interpreted as having any dependency or requirement relating to any one or combination of components illustrated in the exemplary operating environment 1600.

With reference to FIG. 16, an exemplary remote device for implementing the invention includes a user device in the form of a computer 1610. Components of computer 1610 may include, but are not limited to, a processing unit 1620, a system memory 1630, and a system bus 1621 that couples various system components including the system memory to the processing unit 1620. The system bus 1621 may be any of several types of bus structures including a memory bus or memory controller, a peripheral bus, and a local bus using any of a variety of bus architectures.

Computer 1610 typically includes a variety of computer readable media. Computer readable media can be any available media that can be accessed by computer 1610. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1610. Communication media typically embodies computer readable instructions, data structures, program modules or other data in a modulated data signal such as a carrier wave or other transport mechanism and includes any information delivery media.

The system memory 1630 may include computer storage media in the form of volatile and/or nonvolatile memory such as read only memory (ROM) and/or random access memory (RAM). A basic input/output system (BIOS), containing the basic routines that help to transfer information between elements within computer 1610, such as during start-up, may be stored in memory 1630. Memory 1630 typically also contains data and/or program modules that are immediately accessible to and/or presently being operated on by processing unit 1620. By way of example, and not limitation, memory 1630 may also include an operating system, application programs, other program modules, and program data.

The computer 1610 may also include other removable/non-removable, volatile/nonvolatile computer storage media. For example, computer 1610 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment includes, but are not limited to, magnetic tape cassettes, flash memory cards, digital versatile disks, digital video tape, solid state RAM, solid state ROM and the like. A hard disk drive is typically connected to the system bus 1621 through a non-removable memory interface such as an interface, and a magnetic disk drive or optical disk drive is typically connected to the system bus 1621 by a removable memory interface, such as an interface.

A user may enter commands and information into the computer 1610 through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1620 through user input 1640 and associated interface(s) that are coupled to the system bus 1621, but can be connected by other interface and bus structures, such as a parallel port, game port or a universal serial bus (USB). A graphics subsystem may also be connected to the system bus 1621. A monitor or other type of display device is also connected to the system bus 1621 via an interface, such as output interface 1650, which may in turn communicate with video memory. In addition to a monitor, computers may also include other peripheral output devices such as speakers and a printer, which may be connected through output interface 1650.

The computer 1610 can operate in a distributed environment using logical connections to one or more other remote computers, such as remote computer 1670, which can in turn have capabilities different from device 1610. The remote computer 1670 can be a personal computer, a server, a router, a network PC, a peer device or other common network node, or any other remote media consumption or transmission device, and may include any or all of the elements described above relative to the computer 1610. The logical connections depicted in FIG. 16 include a network 1671, such as a wireless local area network (LAN), but may also include other networks/buses.

The computer 1610 is connected to the wireless LAN 1671 through a network interface or adapter having multiple antennas. When used in a WAN networking environment, the computer 1610 typically includes a communications component, such as a modem, or other means for establishing communications over the WAN, such as the Internet. A communications component, such as a modem, which may be internal or external, may be connected to the system bus 1621 via the user input interface of input 1640, or other appropriate mechanism. In a networked environment, program modules depicted relative to the computer 1610, or portions thereof, may be stored in a remote memory storage device.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter can be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

While the present invention has been described in connection with the preferred embodiments of the various figures, it is to be understood that other similar embodiments may be used or modifications and additions can be made to the described embodiments for performing the same function of the present invention without deviating therefrom.

While exemplary embodiments refer to utilizing the present invention in the context of particular networks such as IEEE 802.11-like systems, the invention is not so limited, but rather can be employed in any wireless network to provide methods for multi-packet reception media access control and resource allocation. In particular, the technique can be employed in wireless networks of various sizes, such as wireless personal area networks, wireless metropolitan area networks, and wireless wide area networks. Still further, the present invention can be implemented in or across a plurality of processing chips or devices. Therefore, the present invention should not be limited to any single embodiment, but rather should be construed in breadth and scope in accordance with the appended claims.

What is claimed is:

1. A computer-readable medium that performs a method for transmitting data in a multi-packet reception wireless network, the method comprising:
sensing a channel to determine if there is any pending transmission in a multi-packet reception network;
when the channel is idle for an interval exceeding a first predetermined time,
waiting a random time not to exceed a predetermined initial contention window;
sending a request to send control frame;
when a clear to send control frame is received from a receiver,
waiting a second predetermined time; and
transmitting the data according to parameters specified in the clear to send control frame.

2. The computer-readable medium of claim 1 wherein the transmitting of the data according to parameters specified in the clear to send frame includes transmitting the data by forming space-time-coded OFDM blocks, the space-time coded OFDM blocks formed by pairing two consecutive OFDM symbols specified as part of the parameters.

3. The computer-readable medium of claim 1 wherein the method further comprises when a collision occurs when a request to send is made,
doubling the contention window;
waiting for the channel to be idle for a time exceeding the first predetermined time;
waiting a random time not to exceed the doubled contention window; and
sending a request to send control frame.

4. The computer-readable medium of claim 3 wherein the method further comprises upon successful transmission of a request to send control frame, resetting the contention window to the initial contention window.

5. The computer-readable medium of claim 1, wherein the method further comprises retransmitting a request to send control frame if an acknowledgement from the receiver is not received within an acknowledgement timeout period.

6. The computer-readable medium of claim 1 wherein the wireless network is at least one of a wireless local area network and a MIMO wireless network.

7. The computer-readable medium of claim 1 wherein the receiver is a wireless access point having multiple receiving antennas.

8. A method for facilitating efficient use of a physical layer in a multi-packet reception wireless network, the method comprising:
for each of multiple request to send frames received via one of a plurality of receiving antennas at a receiver;
identifying a transmitter associated with the request to send;
sending an acknowledgment back to the identified transmitter;
determining transmission parameters so as to efficiently use the physical layer for multi-packet reception; and
sending a clear to send frame with the determined transmission parameters to the indicated transmitter.

9. The method of claim 8 wherein sending a clear to send frame with the determined transmission parameters includes sending a clear to send frame with OFDM blocks to use in transmission.

10. The method of claim 8 wherein sending a clear to send frame with the determined transmission parameters includes sending a clear to send frame with subcarrier, bit, and power allocation information.

11. The method of claim 8 wherein the receiver is a wireless access point.

12. The method of claim 8 wherein the wireless network is a MIMO wireless local area network.

13. The method of claim 8 wherein the determining of transmission parameters so as to effectively use the physical layer for multi-packet reception includes determining subcarrier, bit and power allocation information to reduce the amount of airtime used for a data transmission.

14. The method of claim 8 wherein the transmitter is a SIMO device.

15. The method of claim 8 further comprising:
receiving data transmitted from multiple transmitters; and
decoding the data transmitted from each transmitter using the determined parameters.

16. A system for the efficient use of the physical layer in a MIMO-based wireless local network, the system comprising:
a plurality of receiving antennas;
a plurality of transmitting antennas;
a request to send component that receives a request to send frame from a transmitter, the frame includes channel state information;
a transmission parameter component that determines transmission parameters to minimize airtime based at least in part on channel state information supplied in the request to send; and
a clear to send component that generates a clear to send frame with the determined transmission parameters and transmits it to the transmitter that made the request to send.

17. The system of claim 16 further comprising a plurality of user devices, each user device having multiple transmitting antennas and acting as a transmitter that generates request to send requests.

18. The system of claim 16 wherein each receiver further comprises a data receiving component that decodes data transmitted to the receiver based on the determined transmission parameters.

19. The system of claim 18 wherein each receiver further comprises a wide area network access component that communicates decoded data to a wide area network.

20. The system of claim 16 wherein the transmission parameters include subcarrier, bit, and power allocation information.
